(19) United States
(12) Patent Application Publication
(10) Pub. No.: US 2021/0089668 A1
(43) Pub. Date: Mar. 25, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Eiichi MURASE, Kanagawa (JP)

(73) Assignee: FUJI XEROX CO., LTD., Tokyo (JP)

(21) Appl. No.: 16/819,350

(22) Filed: Mar. 16, 2020

(30) Foreign Application Priority Data
Sep. 20, 2019 (JP) 2019-171701

(51) Int. Cl. G06F 21/62; H04L 29/06; G06F 21/84

(52) U.S. Cl. CPC G06F 21/6209; G06F 2221/2113; G06F 21/84; H04L 63/102

(57) ABSTRACT

An information processing apparatus includes a decision unit that decides to restrict displaying of a document if an environment surrounding the information processing apparatus is presumed to be vulnerable to information leakage when the displaying of the document is requested and a display controller that, if the decision unit has decided to restrict the displaying, performs control to display the document on condition that attribute information on the document satisfies an exception condition.

### CROSS-REFERENCE TO RELATED APPLICATIONS

This application is based on and claims priority under 35 USC 119 from Japanese Patent Application No. 2019-171701 filed Sep. 20, 2019.

### BACKGROUND

### (i) Technical Field

The present disclosure relates to an information processing apparatus and a non-transitory computer readable medium.

### (ii) Related Art

For the security point of view, a variety of techniques is disclosed to restrict the viewing of documents. For example, Japanese Unexamined Patent Application Publication No. 2011-134137 discloses a display control technique that changes a portion of a document under view restriction to a difficult-to-view display form if the presence of a person other than a person having browsing right is detected near an information terminal device displaying the document.

If an information processing apparatus is used in a public environment, content displayed on the information processing apparatus may be viewed by a third party and information may thus be leaked. If an environment surrounding the information processing apparatus is presumed to be vulnerable to information leak, the information leakage may be controlled for the security point of view by setting the document to be in a difficult-to-view state or restricting the displaying of the document or not displaying the document at all.

However, even if the environment surrounding the information processing apparatus is presumed to be vulnerable to information leak, the user may have to display the document to perform a job with a high degree of urgency. The document may be desirably displayed for convenience of the user in any possible manner.

### SUMMARY

Aspects of non-limiting embodiments of the present disclosure relate to exceptionally permitting exceptional displaying of a document in response to attribute information of the document while still restricting the displaying of the document in view of an environment surrounding an information processing apparatus presumed to be vulnerable to information leak.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a decision unit that decides to restrict displaying of a document if an environment surrounding the information processing apparatus is presumed to be vulnerable to information leakage when the displaying of the document is requested and a display controller that, if the decision unit has decided to restrict the displaying, performs control to display the document on condition that attribute information on the document satisfies an exception condition.

### BRIEF DESCRIPTION OF THE DRAWINGS

Exemplary embodiment of the present disclosure will be described in detail based on the following figures, wherein:

FIG. 1 is a block diagram illustrating an information processing apparatus of an exemplary embodiment of the disclosure;

FIG. 2 illustrates a data configuration of document information stored on a document information memory of the exemplary embodiment;

FIG. 3 illustrates a data configuration of security level information stored on a security level information memory of the exemplary embodiment;

FIG. 4 illustrates a data configuration of job information stored on a job information memory of the exemplary embodiment;

FIG. 5 illustrates a data configuration of time limit information stored on a time limit information memory of the exemplary embodiment; and

FIG. 6 is a flowchart illustrating a display control process of a document in accordance with the exemplary embodiment.

### DETAILED DESCRIPTION

Exemplary embodiment of the disclosure is described below with reference to the drawings.

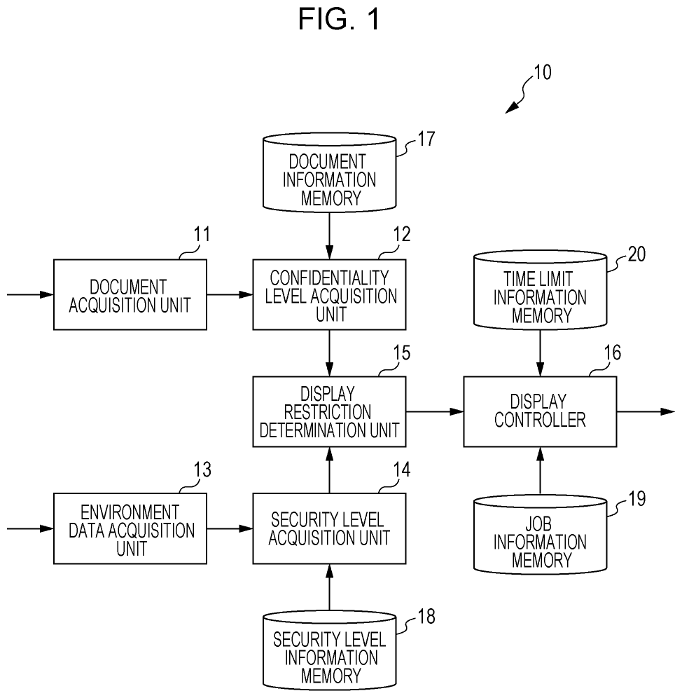

FIG. 1 is a block diagram illustrating a mobile terminal 10 as an information processing apparatus of an exemplary embodiment of the disclosure. The mobile terminal 10 of the exemplary embodiment is a portable information processing apparatus and may be implemented by a mobile personal computer (PC), a tablet terminal, a smart phone, or the like. The mobile terminal 10 may be implemented by a general-purpose hardware configuration available in the related art. The mobile terminal 10 includes a central processing unit (CPU), a memory, such as read-only memory (ROM), random-access memory (RAM), or a hard disk drive, and a communication medium, such as a user interface or a network interface connected to the Internet and performing near field communication. The user interface is different depending on the type of the mobile terminal 10. For example, if the mobile terminal 10 is the mobile PC, the mobile terminal 10 includes an input unit, such as a keyboard and/or a mouse and a display unit, such as a liquid-crystal panel. If the mobile terminal 10 is a smart phone or tablet terminal, a touch-panel type liquid-crystal panel serves as both the input unit and the display unit.

The mobile terminal 10 is configured to collect information about the state of an environment surrounding the information processing apparatus. This configuration is based on a mechanism that is mounted on the mobile terminal 10. The mechanism may not necessarily be included in the mobile terminal 10. The mechanism may be externally attached to the mobile terminal 10 or data may be acquired from an external device. For convenience of description, the mechanism is mounted on the mobile terminal 10. The mechanism may include a variety of sensors including a microphone picking up an ambient sound, a camera photographing a surrounding environment, an accelerometer, a gyro sensor, and/or a temperature sensor. In the following discussion, data representing the state of the environment surrounding the mobile terminal 10 is referred to “environment data”, and a mechanism collecting the environment data from the microphone and camera is referred to as a “collection unit”.

Referring to FIG. 1, the mobile terminal 10 of the exemplary embodiment includes a document acquisition unit 11, confidentiality level acquisition unit 12, environment data acquisition unit 13, security level acquisition unit 14, display restriction decision unit 15, display controller 16, document information memory 17, security level information memory 18, job information memory 19, and time limit information memory 20.

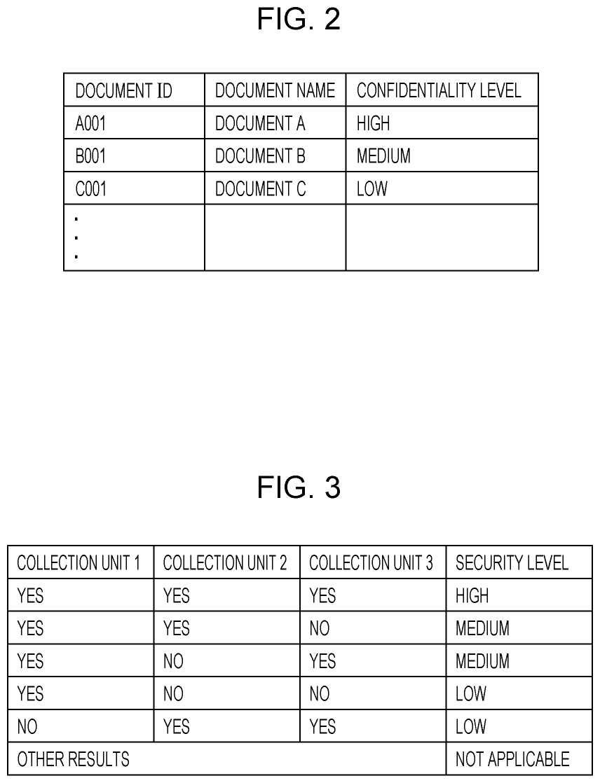

FIG. 2 illustrates a data configuration of document information stored on the document information memory 17 of the exemplary embodiment. The document information includes information on a document that the mobile terminal 10 processes as a display target and includes a document identification (ID) identifying each document, document name, and confidentiality level of the document in association with each other. The confidentiality level is set by the creator of the document or administrator and is an index that indicates a level at which the document is to be kept secret. A higher index sets a higher confidentiality level. In accordance with the exemplary embodiment, each document is set at one of three confidentiality levels, including “high”, “medium”, and “low”. The number of confidentiality levels is described for exemplary purposes and is not limited to the three levels.

FIG. 3 illustrates a data configuration of security level information stored on the security level information memory 18 of the exemplary embodiment. The security level information relates to multiple collection units associated with security levels. The collection units 1 through 3 collect the environment data. If the environment surrounding the mobile terminal 10 is determined to be secure by referring to the environment data collected by the collection unit, “yes” is set in the column of the corresponding collection unit. If the environment surrounding the mobile terminal 10 is determined to be insecure, “no” is set in the column of the corresponding collection unit. The security of the environment surrounding the mobile terminal 10 is determined based on the determination results concerning the secure status or insecure status of each of the collection units 1 through 3. The level of the security of the environment is referred to as the security level. The security level is set by the administrator of the document. As the security level is higher, the environment surrounding the mobile terminal 10 is more secure. A secure environment means that the environment surrounding the mobile terminal 10 is presumed to not be vulnerable to information leakage. An insecure environment means that the environment surrounding the mobile terminal 10 is presumed to be vulnerable to information leakage. In accordance with the exemplary embodiment, four security levels “high”, “medium”, “low”, and “not applicable” are used. The security level “not applicable” indicates a high-risk environment in which the environment surrounding the mobile terminal 10 is not secure at all and information on the document may possibly be leaked. In accordance with the exemplary embodiment, three types of collection units are used to determine the security of the environment surrounding the mobile terminal 10. The number of collection units used is not limited to three. The use of one or more collection units is sufficient. Since the security level is compared with the confidentiality level described previously, comparable values are desirably used. The security level information is described further in the discussion of the system operation.

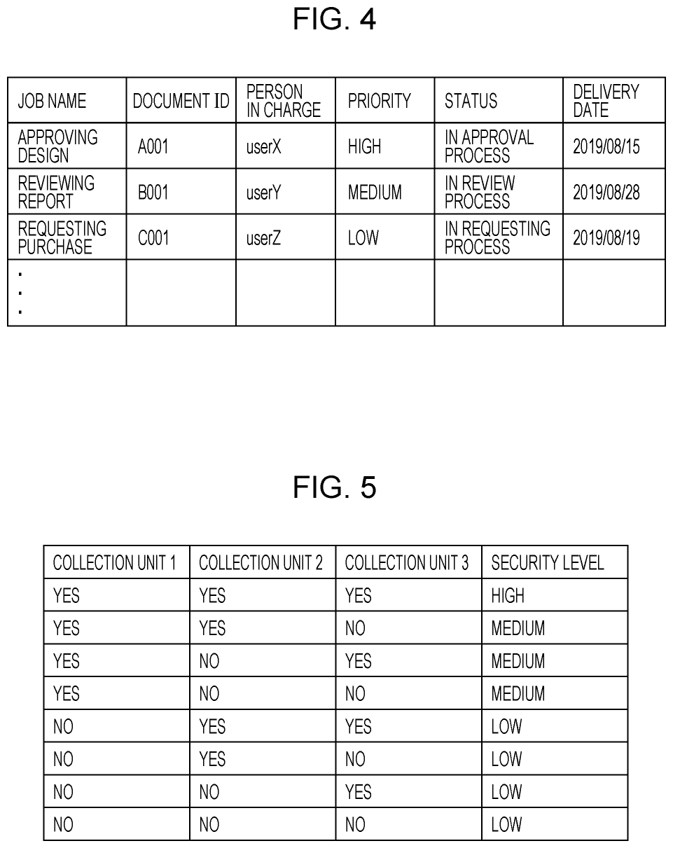

FIG. 4 illustrates a data configuration of job information stored on the job information memory 19 of the exemplary embodiment. The job information identifies the job to which the document is tied and indicates the status of the document in the job. The job information is thus a type of attribute information of the document. The job information includes in an associated form a job name that identifies the corresponding job, a document ID of the document tied to the job, a person in charge who identifies a user editing and managing the document, a priority of the document in the job, a current status of the document, and a delivery indicating the submission deadline of the document or the completion date of the document. The priority is set by the administrator of the document and is an index in accordance with which the job is processed on a priority basis. A higher index sets a higher priority level. Since the priority also indicates the degree of importance of the document in the job, it is considered to be an index of importance. In accordance with the exemplary embodiment, the priority levels are “high”, “medium”, and “low”. The number of priority levels is described for exemplary purposes and is not limited to the three levels.

FIG. 5 illustrates a data configuration of time limit information stored on the time limit information memory 20 of the exemplary embodiment. The time limit information is used to set a time limit for display time when the document is displayed. The time limit information includes time limits associated with multiple collection units. In the same manner with the security level information, the collection units 1 through 3 collect the environment data. If the environment surrounding the mobile terminal 10 is determined to be secure by referring to the environment data collected by the collection unit, “yes” is set in the column of the corresponding collection unit. If the environment surrounding the mobile terminal 10 is determined to be insecure, “no” is set in the column of the corresponding collection unit. The time length of displaying the document on the mobile terminal 10 as the time length is determined based on the determination results concerning the secure status or insecure status of each of the collection units 1 through 3. The administrator of the document sets the time limit by referencing the item values in the collection units 1 through 3. Basically, the administrator sets the time limit such that the time limit is longer as the surrounding environment is more secure. “Not applicable” means that the time limit is zero minutes and the document is not displayed. The time limit may not necessarily be determined by weighting the collection units and by counting the number of “yeses” as illustrated in FIG. 5.

The document acquisition unit 11 acquires a document as a display target. The confidentiality level acquisition unit 12 acquires from the document information memory 17 the confidentiality level of a document acquired by the document acquisition unit 11. The environment data acquisition unit 13 acquires the environment data from the collection unit. In accordance with the exemplary embodiment, the environment data may be simply acquired from the collection unit that is set in at least the security level information and time limit information. Based on the environment data acquired by the environment data acquisition unit 13, the security level acquisition unit 14 determines the security level of the environment surrounding the mobile terminal 10. When the displaying of the document is requested, the environment surrounding the mobile terminal 10 may be presumed to be vulnerable to information leakage in accordance with the relationship between the confidentiality level of the document and the environment surrounding the mobile terminal 10. In such a case, the display restriction decision unit 15 decides to restrict the displaying of the document. Even if the display restriction decision unit 15 has decided to restrict the displaying, the display controller 16 performs control to display the document if the attribute information on the document satisfies a predetermined exception condition. The “restriction” on the displaying decided by the display restriction decision unit 15 includes not only not displaying the whole or part of the document but also displaying the document that is set to be harder to view than when the document is displayed as is.

The elements 11 through 16 of the mobile terminal 10 are implemented when the computer forming the mobile terminal 10 is operating in concert with a program running on a CPU in the computer. The elements 17 through 20 are implemented by a hard disk drive (HDD) in the mobile terminal 10. A RAM may be used or an external memory may be used via a network.

The program of the exemplary embodiment may be provided via a communication medium or may be provided in a recorded form on a non-transitory computer readable recording medium, such as a compact disk read-only memory (CD-ROM).

The process of the exemplary embodiment is described below.

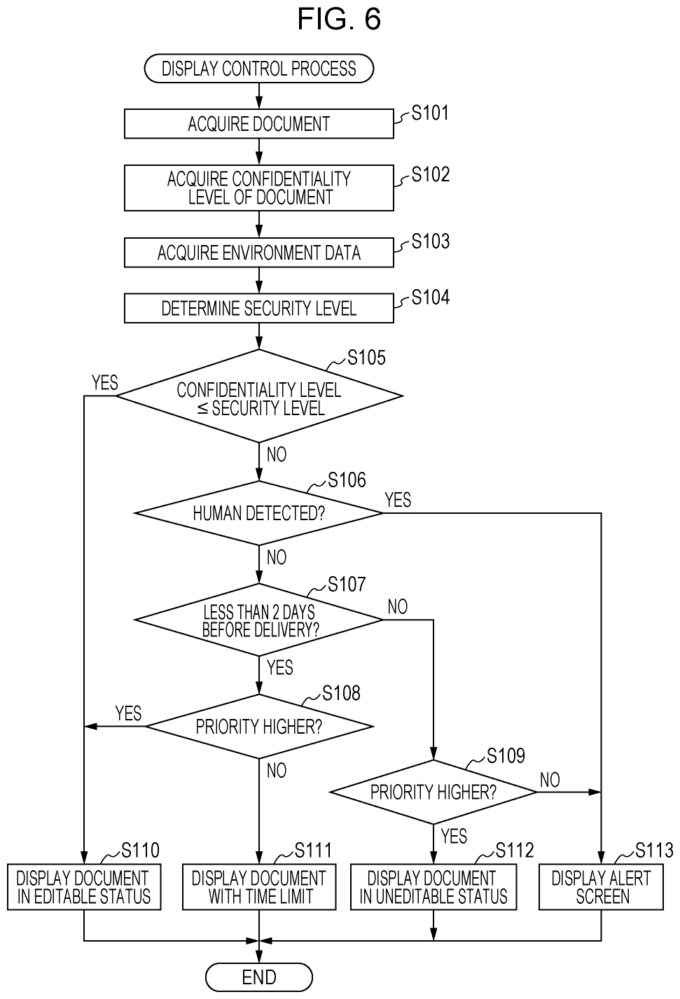

The user may wish to carry the mobile terminal 10 out of an office for some reason and cause the mobile terminal 10 to display a document at a destination venue. The destination venue may be not secure. The mobile terminal 10 is typically controlled such that any document may not be displayed at an insecure place. In accordance with the exemplary embodiment, even if the environment surrounding the mobile terminal 10 is presumed to be vulnerable to information leakage when the displaying of the document is requested, the mobile terminal 10 performs display control to display the document if a predetermined exception condition is satisfied. The display control process to display the document is described with reference to a flowchart in FIG. 6.

The user requests the mobile terminal 10 to display the document by performing a predetermined operation. The document acquisition unit 11 acquires a document as a display target in response to the user operation (step S101). The document may be acquired from within or outside the mobile terminal 10. When the document has been acquired, the confidentiality level acquisition unit 12 acquires the confidentiality level of the document by referencing document information on the document stored on the document information memory 17 (step S102).

The environment data acquisition unit 13 acquires the environment data from the collection unit set in the security level information and the time limit information (step S103). The security level acquisition unit 14 determines the security level of the environment surrounding the mobile terminal 10 in accordance with the environment data acquired by the environment data acquisition unit 13 (step S104). The security level information stored on the security level information memory 18 and the determination method to determine the security level are described below.

The collection unit is a microphone or a camera, mounted on the mobile terminal 10. If the collection unit is a microphone, audio data of a picked-up sound is the environment data. A volume acquired from the audio data is regarded as a volume of noise surrounding the mobile terminal 10 and the security level acquisition unit 14 determines from the volume whether the ambient environment of the mobile terminal 10 is quiet or noisy. If the ambient environment is noisy, the user may possibly be outdoors. In such a case, the user is presumed to be at an insecure place in accordance with the exemplary embodiment. Since the user uses the mobile terminal 10, the location of the user and the location of the mobile terminal 10 match each other. The location of the user is thus identical to the location of the mobile terminal 10.

In accordance with the exemplary embodiment, a threshold value of the magnitude of a sound is predetermined and if the picked-up volume level is equal to or higher than the predetermined value, the mobile terminal 10 is presumed to be used outdoors. In such a case, the determination of the security in accordance with the environment data from the collection unit is insecure and is thus no. On the other hand, if the picked-up volume level is lower than the threshold value, the mobile terminal 10 is presumed to be used indoors. In such a case, the determination of the security in accordance with the environment data from the collection unit is secure and is thus yes.

If the collection unit is a camera, image data is the environment data. A person present surrounding the mobile terminal 10 (more strictly, in an imaging area of the camera) may be detected by analyzing the image data. The word “person” herein refers to a human capable of reading a document. In the following discussion, the human is simply described as a person. Information learned from the environment data may be the number of persons, locations of the persons, and distance to each person. In this case, a person at a location within a display screen of the mobile terminal 10 is detected. The distance to the person may be used as an index. If the distance to the person is shorter, that person is presumed to be able to read the document displayed on the display screen of the mobile terminal 10. In accordance with the exemplary embodiment, the longest distance across which the document displayed on the display screen is readable is preset as a threshold value. If the distance to the person acquired from the image data is shorter than the threshold value, the document displayed on the display screen is presumed to be readable. In such a case, the determination of security based on the environment data from the collection unit (the image data herein) is not secure and is thus no. On the other hand, if the distance to the person acquired from the image data is equal to or longer than the threshold value, the document displayed on the display screen is presumed to be not readable. In such a case, the determination of security based on the environment data from the collection unit (the image data herein) is secure and is thus yes.

As previously described, the security is determined using the distance to the person as an index. The exemplary embodiment is not limited to this index. If the number of persons learned from the environment data is equal to or larger than a predetermined threshold value set in the number of persons, the environment surrounding the mobile terminal 10 is presumed to be insecure and the determination of security is insecure and is thus “no”.

If the collection unit is a camera, the environment data includes a user carrying the mobile terminal 10 (hereinafter referred to as an “authorized user”). The authorized user is likely to be in the nearest location to the front of the display screen of the mobile terminal 10 and to operate the mobile terminal 10. It is thus possible to exclude the authorized user from the persons that have been detected by analyzing the image data. A third person may possibly look into the display screen from behind the authorized user. The third person may thus be detected by referencing not only the distance from the mobile terminal 10 to the person but also location of and direction to the detected person.

If the collection unit is an accelerometer, acceleration detected by the accelerometer is the environment data. Whether the user holding the mobile terminal 10 is moving or not is determined by detecting a time change in the acceleration. It is not desirable that the user displays and processes a confidential document on the mobile terminal 10 while moving in location. In accordance with the exemplary embodiment, a typical traveling speed of the user is preset as a threshold value and if the traveling speed calculated from the acceleration is equal to or higher than the threshold value, the displaying of the document is determined to be inappropriate. The security when the user displays and process the document while moving is determined to be insecure, namely, no. On the other hand, if the traveling speed calculated from the acceleration is lower than the threshold value, the state with the document displayed on the mobile terminal 10 is determined to be appropriate. Namely, the security in this state is determined to be secure, namely, yes.

As described above, the collection unit is a microphone, camera, or accelerometer, and the security of the environment is determined depending on the location where the mobile terminal 10 is used, the presence of a nearby person, or the usage status as to whether the user is moving or not. Another type of collection unit may be used. In such a case as well, a threshold value is appropriately set up and the security of the environment surrounding the mobile terminal 10 is then determined.

The security level acquisition unit 14 determines the security level of the environment surrounding the mobile terminal 10 in accordance with a combination of determination results “yes” and “no” of multiple collection units (the collection units 1 through 3 in FIG. 3). The determination result “yes” denotes a secure environment and the determination result “no” denotes an insecure environment. In the setting example in FIG. 3, if the collection units 1 through 3 provide yes, the security level is determined to be high. If the collection units 1 and 3 provide yes but the collection unit 2 provides no, the security level is determined to be medium.

The confidentiality level and security level acquired in the process described above are used in the operation in step S105. Since it is acceptable as long as the confidentiality level and security level are acquired before step S105, the order of acquisition of the confidentiality level and security level illustrated in FIG. 6 may be reversed.

The display restriction decision unit 15 determines whether to restrict the displaying of the document in accordance with the confidentiality level and security level acquired in the process described above. Specifically, if the confidentiality level of a document is lower than the security level, the display restriction decision unit 15 determines that the displaying of the document has been requested under the secure environment that satisfies the confidentiality level of the document (yes path from step S105) and thus decides to display the document without restriction. In such a case, the display controller 16 displays the document in an editable status (step S110).

If the confidentiality level of the document is higher than the security level, the display restriction decision unit 15 determines that the displaying of the document has been requested under an insecure environment that does not satisfy the confidentiality level of the document (no path from step S105). The display restriction decision unit 15 decides basically to not display the document. However, the state with no document displayed may possibly inconvenience the user. In accordance with the exemplary embodiment, the displaying of the document is conditionally permitted in view of the inconvenience if a predetermined exception condition is satisfied.

The display controller 16 controls the displaying of the document in response to the presence or absence of a person surrounding the mobile terminal 10. The presence or absence of a person is determined by analyzing the image data from the camera. If the camera is one of the collection units included in the security level information, the determination operation results of the security level may be effectively used. If the camera is none of the collection units included in the security level information, the presence or absence of a person may be determined by analyzing the current image data. If the mobile terminal 10 does not include a camera as the collection unit, the environment data obtained via a different collection unit may be analyzed. For example, the audio data from the microphone is analyzed and a conversation, if detected, confirms the presence of nearby persons. If an infrared sensor is mounted as a collection unit, sensor data is analyzed to detect the presence of a person other than the authorized user.

If a person is detected surrounding the mobile terminal (yes path from step S106), the display controller 16 determines that there is a possibility that the display screen of the mobile terminal 10 is looked into and the display restriction decision unit 15 maintains the decision of keeping the document undisplayed. In such a case, an alert screen conveying this decision to the user is displayed on the display screen (step S113). By seeing the alert screen, the user recognizes that the document is not displayed. The user may then request again the mobile terminal 10 to display the document when he or she moves to a location where no other persons are present.

If no person is detected surrounding the mobile terminal 10 (no path from step S106), the display controller 16 permits the mobile terminal 10 to display the document. Only if no person is detected surrounding the mobile terminal 10, the display controller 16 performs control to display the document in a process described below.

The display controller 16 acquires the delivery of the document as a display target by referencing job data. The display controller 16 compares the current date and time with the delivery. If less than 2 days remains until the delivery (yes path from step S107), the display controller 16 references the priority of the document in the job data. If the priority is “high” (yes path from step S108), the display controller 16 causes the mobile terminal 10 to display the document in an editable status such that the document is processed early to meet the delivery (step S110). In this way, the job is set to have a priority higher than the security.

If less than 2 days remain before the delivery (yes path from step S107) and the priority is not “high” (no path from step S108), the display controller 16 performs control to display the document with a time limit (step S111). The display controller 16 determines the display time length by referencing the time limit information. In the same manner as in the determination of the security level, the display controller 16 determines the time limit, in other words, the display time length in accordance with the combination of “yes” and “no” for the collection units, namely, in accordance with the degree of possibility that the environment surrounding the mobile terminal 10 is vulnerable to information leakage. In the setting example in FIG. 5, if all the collection units determine that the environment is secure, the mobile terminal 10 is caused to display the document with no particular time limit. If the time limit is not applicable, the document is not displayed and the alert screen may be displayed as in step S113. By presenting on the alert screen a message telling the reason why the document is not displayed, the user may request the mobile terminal 10 to display the document again after the reason is resolved.

If 2days or more remain before the delivery (no path from step S107), the display controller 16 references the priority of the document as the display target by referencing the job data. If the priority is “high” (yes path from step S109), the display controller 16 causes the mobile terminal 10 to display the document in an uneditable status (step S112). Note in this case that the delivery is not very early but the priority of the document is higher. Namely, the user is permitted only to view the document. With 2 days or more before the delivery (no path from step S107) and the priority being “high” (no path from step S109), the display controller 16 maintains the decision by the display restriction decision unit 15 to place a higher priority on the security than the job and does not cause the mobile terminal 10 to display the document. In this case, the alert screen conveying the decision to the user is displayed on the display screen (step S113).

If the displaying of the document is requested in an insecure environment in the exemplary embodiment, the displaying of the document is basically restricted. However, if the exception condition is satisfied, the document may be displayed or conditionally displayed depending on the degree of the satisfaction.

In accordance with the exemplary embodiment, the three priority levels are used. Only the priority level “high” has the highest priority. The priority level “medium” may also be categorized into the priority level “high”. The priority level that is categorized into the highest priority may be appropriately set up.

The predetermined time indicating the time length to the delivery is 2 days in the above discussion. This is described for exemplary purposes only. Values and unit of the predetermined time are not limited those described above and may be appropriately determined in view of contents of the job.

In the control process described above, the displaying of the document is controlled depending on the attribute information of the document set in the job data, specifically, depending on whether the exception condition based on the priority and delivery is satisfied. The attribute information to be referenced is not limited to the attribute information described above. The exception condition may be determined based on at least one of the priority and the delivery. Alternatively, another index may be used for the exception condition. For example, a creator of a document or a degree of importance may be used for the exception condition.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a decision unit that decides to restrict displaying of a document if an environment surrounding the information processing apparatus is presumed to be vulnerable to information leakage when the displaying of the document is requested, and
a display controller that, if the decision unit has decided to restrict the displaying, performs control to display the document on condition that attribute information on the document satisfies an exception condition.

2. The information processing apparatus according to claim 1, wherein the exception condition includes a condition related to at least one of a priority of the document on job and a delivery of the document.

3. The information processing apparatus according to claim 2, wherein the display controller performs control to display the document in an editable status if the exception condition is satisfied wherein the exception condition is that a time length from when the displaying of the document is requested to the delivery of the document is shorter than a predetermined time length and the priority of the document is equal to or higher than a threshold value.

4. The information processing apparatus according to claim 2, wherein the display controller performs control to display the document within a time limit if the exception condition is satisfied wherein the exception condition is that a time length from when the displaying of the document is requested to the delivery of the document is shorter than a predetermined time length and the priority of the document is lower than a threshold value.

5. The information processing apparatus according to claim 4, wherein the display controller sets a time length of the displaying of the document in response to a level of a possibility of the information leakage through the environment surrounding the information processing apparatus.

6. The information processing apparatus according to claim 2, wherein the display controller performs control to display the document in an uneditable status if the exception condition is satisfied wherein the exception condition is that a time length from when the displaying of the document is requested to the delivery of the document is equal to or longer than a predetermined time length and the priority of the document is equal to or higher than a threshold value.

7. The information processing apparatus according to claim 1, wherein the display controller performs control to not display the document if the exception condition is satisfied wherein the exception condition is that a time length from when the displaying of the document is requested to a delivery of the document is equal to or longer than a predetermined time length and a priority of the document is lower than a threshold value.

8. The information processing apparatus according to claim 1, wherein the display controller performs control to display the document in response to a presence or absence of a person surrounding the information processing apparatus.

9. The information processing apparatus according to claim 2, wherein the display controller performs control to display the document if no person is detected surrounding the information processing apparatus.

10. The information processing apparatus according to claim 3, wherein the display controller performs control to display the document if no person is detected surrounding the information processing apparatus.

11. The information processing apparatus according to claim 4, wherein the display controller performs control to display the document if no person is detected surrounding the information processing apparatus.

12. The information processing apparatus according to claim 5, wherein the display controller performs control to display the document if no person is detected surrounding the information processing apparatus.

13. The information processing apparatus according to claim 6, wherein the display controller performs control to display the document if no person is detected surrounding the information processing apparatus.

14. The information processing apparatus according to claim 7, wherein the display controller performs control to display the document if no person is detected surrounding the information processing apparatus.

15. The information processing apparatus according to claim 8, wherein the display controller performs control to display the document if no person is detected surrounding the information processing apparatus.

16. The information processing apparatus according to claim 8, wherein the display controller performs control to not display the document if a person is detected surrounding the information processing apparatus.

17. An information processing apparatus comprising:
means for restricting displaying of a document if an environment surrounding the information processing apparatus is presumed to be vulnerable to information leakage when the displaying of the document is requested, and
means for performing, with the restricting of the displaying decided, control to display the document on condition that attribute information on the document satisfies an exception condition.

18. A non-transitory computer readable medium storing a program causing a computer to execute a process for processing information, the process comprising:
restricting displaying of a document if an environment surrounding the information processing apparatus is presumed to be vulnerable to information leakage when the displaying of the document is requested, and
with the restricting of the displaying decided, performing control to display the document on condition that attribute information on the document satisfies an exception condition.
